(19) United States
(12) Patent Application Publication
(10) Pub. No.: US 2008/0218343 A1
(43) Pub. Date: Sep. 11, 2008

(54) System for determining presence or absence of individual items making up a set of items normally maintained together in a common location

(76) Inventors: Daniel Joseph Lee, Salt Lake City, UT (US); Leon R. Ashcraft, Salt Lake City, UT (US); Thomas J. Howa, Salt Lake City, UT (US)

Correspondence Address: THORPE NORTH & WESTERN, LLP., P.O. Box 1219, SANDY, UT, 84091-1219, US

(21) Appl. No.: 12/011,465

(22) Filed: Jan. 24, 2008

Related U.S. Application Data
(60) Provisional application No. 60/897,424, filed on Jan. 24, 2007.

(51) Int. Cl. G08B 13/24

(52) U.S. Cl. 340/568.6; 340/568.1; 340/643; 340/500

(57) ABSTRACT

A system for determining presence or absence of individual items making up a set of items normally maintained together as a set in a common location, such as a set of golf clubs normally maintained together in a golf bag, utilizes a magnet secured to each respective item. A magnetic field sensor monitors total magnetic field in the common location as an indicator of missing items. Alternately, a sensor can keep track of items removed from and added to the common location as an indicator of missing items. If one or more items are missing, an alarm, such as an audible and/or visual alarm, can be provided in a desired manner, such as when keeping track of gold clubs in a golf bag, when the golf bag is moved.

### RELATED APPLICATIONS

This application claims the benefit of Provisional Application Ser. No. 60/897,424, filed Jan. 24, 2007, and entitled System For Determining Presence Or Absence Of Individual Items Making Up A Set Of Items Normally Maintained Together In A Common Location. Such application is incorporated herein by reference.

### BACKGROUND OF THE INVENTION

1. Field of the Invention

The present invention relates generally to systems for determining presence or absence of individual items making up a set of items normally maintained together as a set in a common location. Such systems have particular application as systems for sensing and alerting a golfer when the golfer leaves a golf club on the golf course.

2. Related Art

It is common practice during play of a game of golf for a golfer to remove several golf clubs from his or her golf bag and carry them to the location of the ball before deciding which club is needed for a shot. This practice is particularly common when a ball is positioned close to the green and the golfer needs at least two clubs, such as a pitching wedge and a putter, to shoot the ball onto the green and then to putt the ball into the hole. In such instances, the golfer will remove both clubs from his or her golf bag and carry them to the location of the ball. The golfer will then generally use the pitching wedge to shoot the ball onto the green and then drop it on the ground and walk onto the green with the putter to putt the ball into the hole before returning to the golfer's golf bag. In many instances, the golfer will return to the golf bag without remembering to retrieve his or her other club or clubs, thus leaving one or more clubs on the ground while continuing play. It is often not until much later that the golfer finds the club missing from his or her bag and has to remember where it was left and try to find and retrieve it. In some cases, the club cannot be found and is lost to the golfer who then has to replace it.

Many systems have been proposed for alerting a golfer when a golf club is missing from a golf bag. These range from mechanical indicators such as a system where a flag may be biased to extend from a golf club receiving tube when no golf club is present in the tube and to be retracted into the tube by the weight of the golf club acting against the bias when a golf club is present in the tube, to various electronic systems where each golf club may include a radio transmitter that transmits a signal to a receiver that gives an alarm when the distance between the golf club transmitter and the receiver is beyond a preset maximum or a radio transmitter which periodically interrogates transponders on the golf clubs to obtain information regarding the golf clubs. Examples of such systems are shown in U.S. Pat. Nos. 6,967,563, 6,411,211, 6,366,205, 6,118,370, and 5,952,921. There are systems where magnets are positioned on or in the golf clubs and the magnets operate switches when the clubs are positioned in a golf bag so that the absence of a club can be determined. These usually require specific positioning of the golf clubs in a golf bag to operate respective switches. Examples of these systems are shown in U.S. Pat. Nos. 6,023,225 and 5,565,845. U.S. Pat. No. 5,844,483 describes a system where magnetic media containing specific club identification information is attached to each club and a magnetic reader in the golf bag reads the information from each club to determine and identify missing clubs.

While the need for a workable and practical system to determine when a golfer is leaving a club on the course is apparent, applicants are not aware of any of these systems being currently available on a commercial basis.

### SUMMARY OF THE INVENTION

According to the invention, a system for determining presence or absence of individual items making up a set of items normally maintained together as a set in a common location, such as a set of golf clubs normally maintained together in a golf bag, utilizes a magnet secured to each respective item, such as in the grip end of each club shaft, and a detector associated with the common location, such as the golf bag, to determine if all items are present in the common location at any particular time. In one embodiment of the invention, the magnets are positioned with respect to the respective items to which they are secured so as to each add to a total magnetic field strength present in the common location when the respective items are present in the common location. Thus, the magnets secured in the grip ends of golf clubs would all be positioned at the bottom of a golf bag when the clubs are positioned in the golf bag. The magnets in the bottom of the golf bag create a magnetic field in the bottom of the golf bag and the strength of the magnetic field is determined by the number of magnets present. The strength of the field is measured when all clubs are present in the bag. When a club is removed from the bag, it removes a magnet from the bag which reduces the total strength of the magnetic field in the bottom of the bag. By sensing the magnetic field in the bottom of the bag at a particular time and comparing the strength of the field sensed with the strength of the field expected when all clubs are present, an indication of whether a club is missing from the bag is obtained. If a club is indicated as missing, an alarm can be provided. A motion sensor can be included in the system to sense when the bag is moved, and provide an alarm, such as an audible and/or visual alarm, if clubs are missing from the bag when the bag is moved. In addition to sensing the strength of the magnetic field in the bottom of the bag, the sensor can also measure characteristics of the shape of the field to compensate for outside magnetic forces or other influences that might affect the field measurements.

Alternately, or in addition, a sensor to sense the passage of a magnet by the sensor is positioned with respect to the common location to sense the removal of a magnet from the common location or the addition of a magnet to the common location. Thus, such a sensor can be positioned in a golf bag spaced upwardly from the bottom of the bag and from the magnetic field in the bottom of the bag to sense when a magnet passes the sensor and the direction of movement of the magnet as it passes the sensor. This then indicates when a magnet and the golf club to which the magnet is secured is removed from the golf bag and when a magnet and the golf club to which the magnet is secured is added or returned to the golf bag. By starting at a time when it is known that all clubs are in the bag, and keeping track of the number of magnets (golf clubs) removed from the golf bag and the number of magnets (golf clubs) added to the golf bag, it is known at any particular time, such as when a motion sensor indicates movement of the golf bag, whether all golf clubs are in the bag. If one or more golf clubs are missing from the golf bag, an alarm, such as an audible and/or visual alarm, can be provided.

In one embodiment, a system of the invention for determining presence or absence of individual items making up a set of items normally maintained together as a set in a common location, includes a magnet secured to each of the items in the set. The magnets are positioned with respect to each of the items to add to a total magnetic field strength present in the common location when the respective items are present in the common location. At least one magnetic field sensor is positioned with respect to the common location to determine magnetic field strength present at the common location, the magnetic field strength sensed at any particular time being an indication of the number of magnets, and therefore the number of items, present in the common location at that particular time. Means are provided, such as a programmed microprocessor, to compare the magnetic field sensed in the common location at a particular time with the total magnetic field expected if all items are present in the common location to provide an indication if any items are missing from the common location. If an item is indicated as missing, an alarm can be provided.

In another embodiment, a system of the invention for determining presence or absence of individual items making up a set of items normally maintained together as a set in a common location, also includes a magnet secured to each of the items in the set. The magnets are positioned with respect to each of the items so as to enter the common location when the item is added to the common location and to leave the common location when the item is removed from the common location. A sensor is positioned with respect to the common location to sense the movement of a magnet by the sensor and thus to sense the removal of a magnet from the common location or the addition of a magnet to the common location. Means are provided, such as a programmed microprocessor, to keep track of the number of magnets removed and the number of magnets added to the common location, the excess of the number of magnets removed from the common location over the number of magnets added to the common location indicating the number of items missing from the common location. If an item is indicated as missing, an alarm can be provided.

The sensor to sense the movement of a magnet by the sensor and to sense the direction of movement of the magnet by the sensor may include two spaced sensors, each of which can sense the proximity of a magnet to the sensor, such as magnetic sensors which can be Hall effect sensors or magneto resistive devices as available from Honeywell or Philips and used in various compass applications such as automobile compasses, or could be reed switches. With this arrangement, the individual sensors are spaced along the expected path of travel of a magnet during removal and addition of an item to the common location. During removal of an item from the common location the magnet will pass one sensor before passing the other sensor while during addition of the item, the magnet will pass the other sensor and then the one sensor. Thus, during removal of the item one sensor will sense the proximity of the magnet before the other sensor will and during addition of the item, the other sensor will sense the proximity of the sensor before the one sensor will. The order in which the individual sensors sense proximity of the magnet will indicate the direction of movement of the magnet and, thus, whether the item is being removed from or added to the common location. The means to keep track of the number of magnets removed and the number of magnets added to the common location will receive the signals from both sensors and determine from the sequence of the signals whether the signals indicate removal or addition of the item. When reed switches are used, the switches are either open or closed so provide a signal indicating either open or closed. When magnetic sensors such as Hall effect sensors or magneto resistive devices are used, the sensors generally produce an increasing output as a magnet approaches the sensor and a decreasing signal as a magnet moves away from the sensor. Such sensors can also sense background magnetic fields, such as the earth's magnetic field, changes in background magnetic fields, the direction or orientation of the sensor with respect to the earth's magnetic field, and other variables depending upon the particular sensor. In some cases, a single magnetic sensor can be arranged so as to sense the direction of movement of a magnet as it passes by the sensor. Also, the magnetic sensors will usually have a larger range for detection of magnetic fields than will a reed switch.

When used for sensing the presence or absence of a golf club in a golf club bag to prevent loss of golf clubs, the sensors of the system may be provided in an elongate body, such as similar to a golf club shaft, adapted to be positioned in the golf bag similarly to a golf club. If a magnetic field sensor is to be used to measure total magnetic field as an indication of presence or absence of items, the magnetic field sensor may be positioned at one end of the elongate body to be positioned in or near the bottom of the golf bag when the elongate body is positioned in the golf bag. If a sensor or sensors for determining movement of the magnets out of and into the golf bag is used, the sensor or sensor will generally be positioned along the elongate body toward the opposite end thereof to be positioned above the magnetic field sensor and the magnetic field in the bottom of the bag when the elongate body is positioned in the golf bag. Usually, the sensor or sensors for determining movement of the magnets out of and into the golf bag will be positioned near the top or entrance to the golf bag. When the sensor for determining movement of the magnets out of and into the golf bag comprises two individual sensors, the individual sensors will be spaced along the upper portion of the elongate body a distance sufficient to ensure that one sensor will sense the presence of the magnet before the other sensor will as a golf club is either removed from or added to the golf bag. Providing the sensors in an elongate body to be positioned in the golf bag allows the system of the invention to be easily used with any golf bag and to be moved from one golf bag to another. Alternately, the sensors could be built into a golf bag.

A processing unit, such as a microprocessor and associated circuitry, and the indicator and alarm, can also be provided in the elongate body, along with batteries, to provide a complete and self contained unit. Green and red LED's can be provided in the top of the body or along the body where visible to a user to provide a continuous indication of whether all clubs are in the bag (green LED lighted) or whether a club is missing from the bag (red LED lighted). An audible alarm can also be provided upon certain occurrences, such as upon movement of the bag, if all clubs are not present and accounted for. Any type of motion sensor can be used to indicate motion of the bag. If the magnetic sensors mentioned are used to sense movement of the magnets, such sensors could also be used to provide a signal as the bag is moved and changes magnetic heading or orientation. Alternately, the processor and/or the indicator and alarm can be provided in a separate unit, such as a portable unit carried by the golfer, with signals transmitted between the units, such as by radio transmission.

When the system is used for sensing the presence or absence of a golf club in a golf club bag to prevent loss of golf clubs, the magnets may be provided in inserts for the grip end of a golf club. The usual club end piece is removed from the grip end of the club shaft and the insert is inserted into the end of the shaft in its place. The inserts will be configured to grip the inside of the shaft to secure them in place in the end of the shaft.

The invention also provides a method for determining whether all items of a set of items are present in a common location at a particular time. The method includes the steps of securing a magnet to each item of the set. Assembling the set of items in the common location and obtaining a measurement of expected total magnetic field when all items of the set are in the common location. Sensing the total magnetic field at the common location at a particular time when it is desired to know if all items are present in the common location. Comparing the total magnetic field sensed to the expected total field measured when all items are present to determine if all items are present at the particular time. The method also or alternately includes assembling all items in the common location and after assembling all items in the common location, sensing movement of magnets out of and into the common location and keeping track of all magnets removed from the common location and all magnets added to the common location to determine if all items are present in the common location at a particular time.

### BRIEF DESCRIPTION OF THE DRAWINGS

The best mode presently contemplated for carrying out the invention is illustrated in the accompany drawings, in which FIG. 1 is a side elevation of an embodiment of a device of the present invention;

FIG. 2 is a perspective view of the embodiment of FIG. 1 drawn to a larger scale so the controls on the top of the device are visible;

FIG. 3 is a vertical section through a golf bag showing the embodiment of FIGS. 1 and 2 of the invention in place in the golf bag along with three golf clubs;

FIG. 4 is a perspective view of the hand grip section of the embodiment of FIGS. 1 and 2;

FIG. 5 is a different perspective view of the hand grip section of the embodiment of FIGS. 1 and 2;

FIG. 6 is a further different perspective view of the hand grip section of the embodiment of FIGS. 1 and 2;

FIG. 7 is a top plan view of the embodiment of FIGS. 1 and 2 showing the end removed and a door portion of the hand grip section open to show components located within the hand grip section;

FIG. 8 is top plan view of the printed circuit board mounted in the hand grip section of FIG. 7;

FIG. 9 is a top plan view of the circuit board of FIG. 8 with no components mounted;

FIG. 10 is a bottom plan view of the circuit board of FIGS. 8 and 9 with no components mounted;

FIG. 11 is a fragmentary vertical section of an embodiment of an end of a golf club of the system of the invention showing an end piece with magnet that can be used for insertion into the grip end of a golf club; and

FIG. 12 is a block diagram of the circuitry of one embodiment of the invention.

### DETAILED DESCRIPTION OF THE ILLUSTRATED EMBODIMENTS

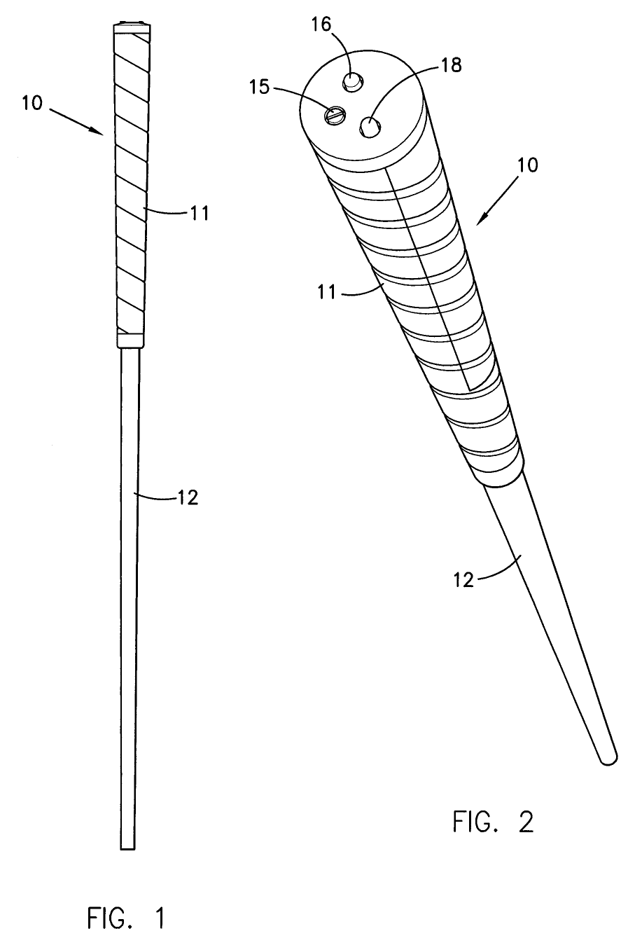

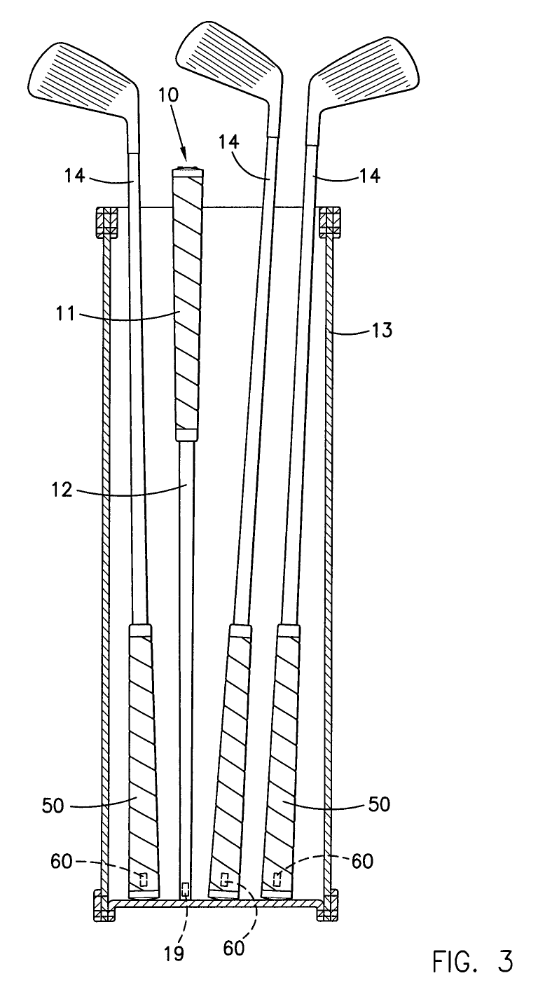

FIGS. 1 and 2 show an embodiment of an elongate body 10 for mounting and housing the sensors, processing unit, indicator, and alarm. As shown, the elongate body 10 can take a form similar to a golf club with a grip section 11 and a shaft 12. A club head or representation of a club head can be included at the end of the shaft opposite the grip section, or the shaft can just end, as shown, without a club head representation. The elongate body 10 is configured to fit into a golf bag 13, FIG. 3, and fit in with the clubs 14 in the bag so is not noticeable as something different in the bag. It is not used as a club. The end of the grip section is shown with a screw 15 to hold the grip section together, a switch 16, and an LED indicator light 18. FIG. 3 shows the elongate body in a golf bag 13 as it is positioned for use. The switch 16 is accessible to a user and the LED indicator 18 is visible to a user.

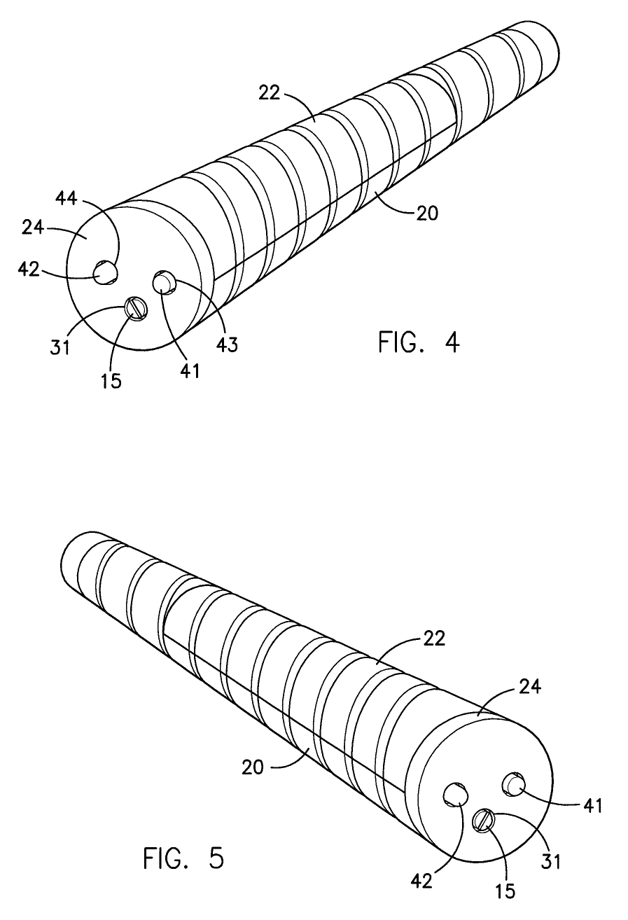

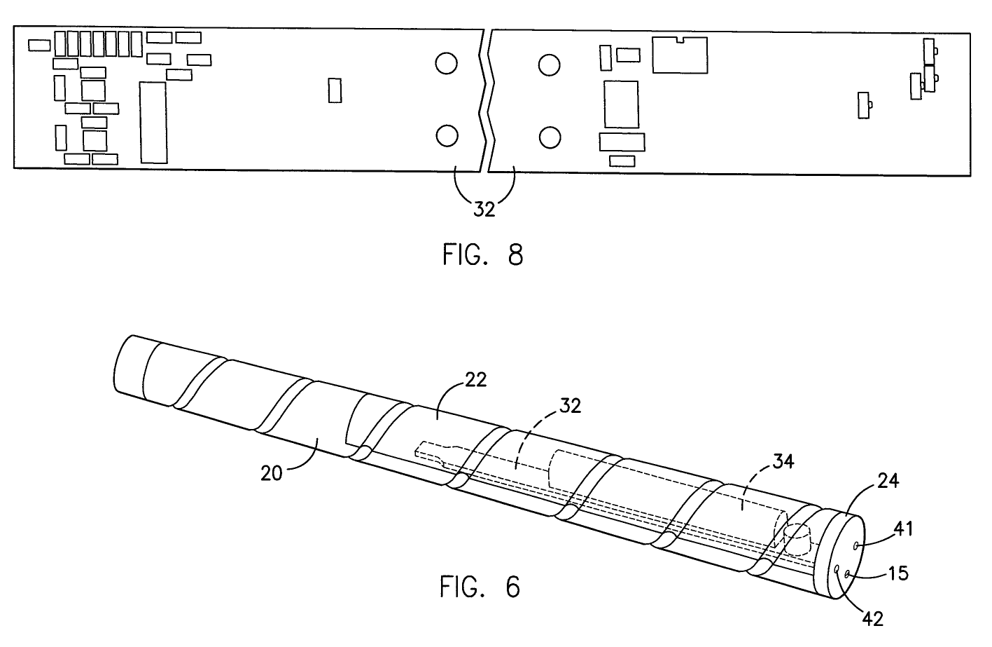

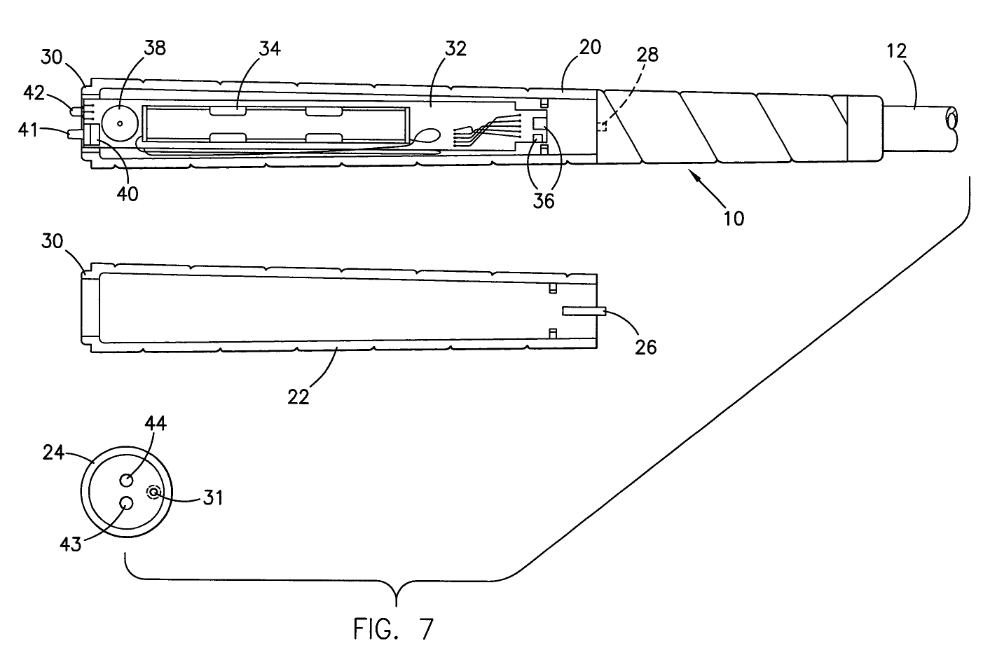

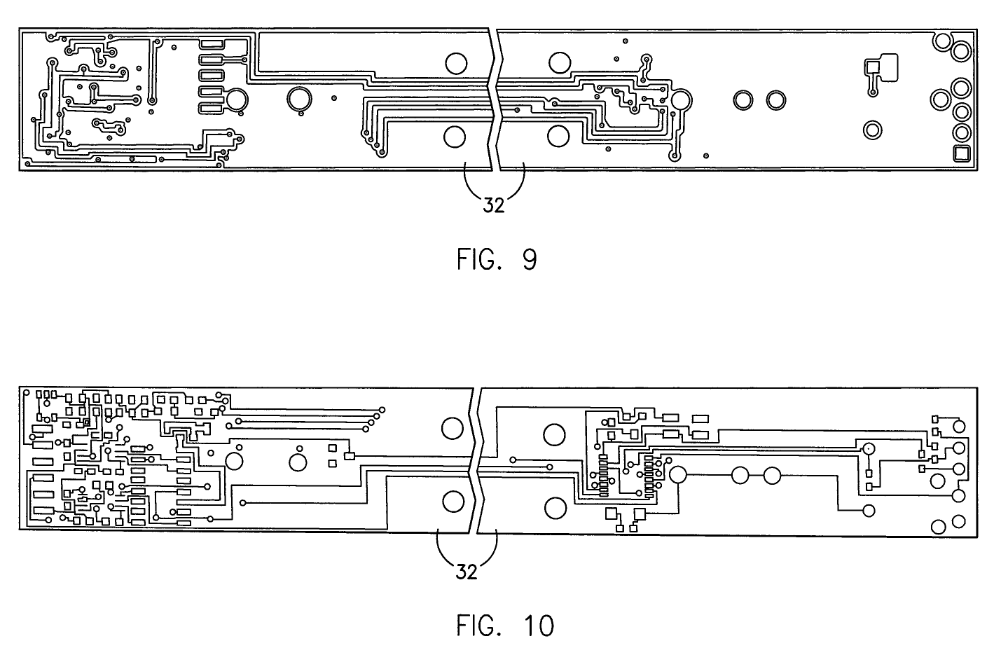

In the embodiment shown, the device keeps track of the golf clubs removed from and added to the golf bag. The sensors are located in the grip section of the body, and no sensors or other components are located in the shaft below the grip section. The shaft is provided to position the grip section in the top portion of the bag. However, if the total magnetic field produced by the golf club magnets in the bottom of the bag is to be measured, one or more total magnetic field sensors could be located in the bottom end of the shaft section of the elongate body 10, such as at a position 19 as shown in FIG. 3. FIGS. 4, 5, and 6 are perspective illustrations of the grip section of the device, and FIG. 7 shows the grip section open to show the components positioned in the grip section. The grip section includes a base 20 with a removable door 22 and an end cap 24. As seen in FIG. 7, door 22 fits into base 20 with tab 26 fitting under the rear edge 28 of the door opening in base 20. With the door 22 in place on base 20, end cap 24 is placed over the end flanges 30 of the base and the door and is secured in place at the end of the grip portion by screw 14 extending through end cap hole 31. This holds the assembly together. Door 22 opens by removal of end cap 24 to expose printed circuit board 32 with battery holder 34, sensors 36, audio alarm device 38, switch 40 with push button 41, and LED 42 mounted thereon. When assembled, the switch button 41 extends through end cap hole 43 so as to be operable by a user and the end of LED 42 extends through end cap hole 44 to be visible to a user. LED 42 is a two color red and green LED. A microprocessor and other components forming a processing unit are mounted on the opposite side of the printed circuit board and are not visible in FIG. 7, however, they are shown on the circuit board drawing FIG. 8. An embodiment of both sides of the printed circuit board without components mounted is shown in FIGS. 9 and 10.

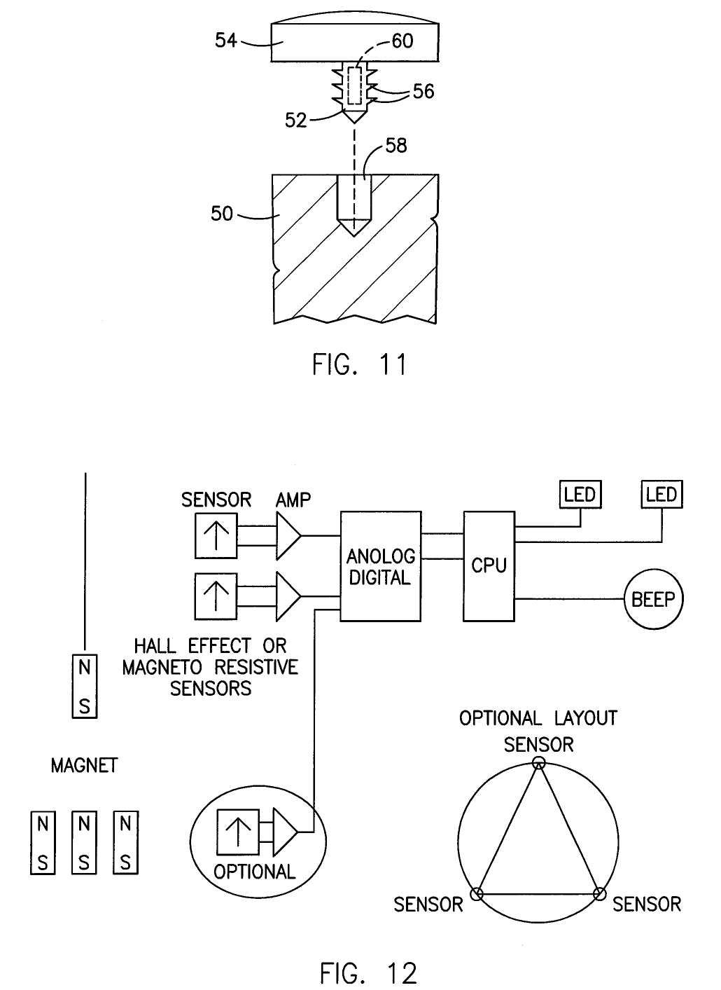

FIG. 11 shows an embodiment of an end piece with magnet that can be used for insertion into the grip end 50 of a golf club such as a club 14 of FIG. 3. The end piece includes a shaft 52 extending from a base 54 sized and configured to match the grip end 50 of the golf club. Shaft 52 includes deformable fingers 56 to fit into club end bore 58. A magnet 60 is embedded or otherwise enclosed in shaft 52. To insert the magnet into the golf club, the normal end piece on the club is removed and shaft 52 is pushed into end bore 58 until base 54 is against the end of the club. Fingers 56 will deform and hold the end piece in the end of the club. Various other ways of securing a magnet to the golf club can be used.

In use in using the particular embodiments shown, the golf clubs to be protected from being left on a golf course are each fitted with a magnet. The clubs are all placed in a golf bag along with the elongate body housing the sensors, processing unit, indicator, and alarm. With all golf clubs in the bag, the unit is turned on by operation of the push button 41. With all clubs present, the LED 42 lights green. When a club is removed from the bag, the sensors sense its removal and the processing unit, knowing that a club is missing, changes the polarity on the LED so that the LED 42 lights red. If a club is returned to the bag, the sensors sense the return and the processing unit determines that one club was removed and now one club is returned so that all clubs are again present in the bag and changes the LED so that it lights green. If two clubs are removed from the bag, the processing unit keeps track that two clubs have been removed and if only one club is returned, the processing unit knows that the bag is short a club. The LED remains red to show that all of the clubs are not in the bag. If the second club is returned, the processing unit knows all clubs are back in the bag and the LED lights green. If the bag is moved so that a sensor changes its heading or orientation with respect to the earth's magnetic field, the processing unit receives that indication from at least one of the sensors and, if all clubs are not in the bag, sounds the audible alarm to alert the golfer that he or she is leaving a club. The processing unit will keep track of the number of clubs removed from the bag and the number returned so will always know if all clubs are back in the bag or if one or more clubs are missing from the bag. The processing unit will start with a new count each time the unit is turned off and then turned on again. In this way, the system will adapt to a round of golf with the golfer only carrying some of the golfer's clubs, or will adapt to being moved to a different bag with a different number of clubs. The system can be programmed in various ways to perform various functions in various ways. The processing unit will usually include a microprocessor or similar computer unit connected to receive input signals from the various sensors and preprogrammed to operate in at least one of the ways described herein, or a similar way, to determine when and if all clubs are present in the golf bag, or to otherwise keep track of items making up a set of items that are normally maintained together in a common location.

FIG. 12 is a block diagram of the circuitry of one embodiment of the invention. The sensors sense the movement of a magnet near the sensors with each sensor producing a signal as the magnet passes by the sensor. The sensor that produces a peak output first indicates the direction of movement of the magnet or golf club. The outputs of the sensors are amplified and sent to an analog to digital converter with the corresponding digital signals then sent to the CPU such as a microprocessor. The CPU then determines if all clubs are present in the bag and causes the LED to light red or green (shown as two separate LED's). If movement of the bag is sensed and it is appropriate to sound the alarm, the CPU activates the BEEP. Optional additional sensors can be connected through the analog to digital converter to the CPU to provide other signals which can determine if two or more clubs are removed simultaneously. Two optional sensor arrangements are indicated.

As previously indicated, according to the invention, the presence or absence of an item can alternately be determined by measuring the strength of the magnet field produced by all items together and then measuring the strength of the field at any time when it is desired to determine if all items are present. In such an embodiment a magnet is secured, as described, to each of the items in the set. The magnets are positioned with respect to each of the items to add to a total magnetic field strength present in the common location when the respective items are present in the common location. As shown in FIG. 3, the magnets 60 in each of the golf club handles will add to produce a total magnetic field in the bottom of the golf bag 13. At least one magnetic field sensor is positioned, such as at 19 in elongate body 10, with respect to the common location, the golf bag, to determine magnetic field strength present at the common location, i.e., at the bottom of the golf bag. The total magnetic field strength sensed at any particular time is an indication of the number of magnets, and therefore the number of items, present in the common location at that particular time. The signals from the sensor, such as at 19, are sent to the processing unit, such as the microprocessor in the handle section 11 of the elongate body 10, which in this instance is programmed to compare the total magnetic field sensed with the total magnetic field expected if all items are present in the common location to provide an indication if any items are missing from the common location. If an item is indicated as missing, the processing unit is programmed to provide an alarm in a desired manner, such as when movement of the golf bag is sensed.

Also as previously indicated, the invention also provides a method for determining whether all items of a set of items are present in a common location at a particular time. The method includes the steps of securing a magnet to each item of the set. The items of the set of items are assembled in the common location and a measurement of expected total magnetic field when all items of the set are in the common location is obtained. The total magnetic field in the common location is sensed at a particular time when it is desired to know if all items are present in the common location. The total magnetic field sensed at the particular time is compared to the expected total field measured when all items are present to determine if all items are present at the particular time. The method also or alternately includes assembling all items in the common location and after assembling all items in the common location, sensing movement of magnets out of and into the common location and keeping track of all magnets removed from the common location and all magnets added to the common location to determine if all items are present in the common location at a particular time.

While the forgoing examples are illustrative of the principles of the present invention in one or more particular applications, it will be apparent to those of ordinary skill in the art that numerous modifications in form, usage, and details of implementation can be made without the exercise of inventive faculty, and without departing from the principles and concepts of the invention. Accordingly, it is not intended that the invention be limited, except as by the claims set forth below.

1. A system for determining presence or absence of individual items making up a set of items normally maintained together as a set in a common location, comprising:
a set of items normally maintained together as a set in a common location;
a magnet secured to each respective item in the set of items, each magnet positioned with respect to the respective item to which it is secured so as to add to a total magnetic field strength present in the common location when the respective item is present in the common location;
at least one magnetic field sensor positioned with respect to the common location to determine magnetic field strength present at the common location, the magnetic field strength sensed being an indication of the number of magnets present in the common location, the number of magnets present being an indication of whether all items of the set are present in the common location; and
means to compare the magnetic field sensed in the common location at a particular time with the expected total magnetic field if all items are present in the common location to provide an indication if any items are missing from the common location.

2. A system for determining presence or absence of individual items making up a set of items normally maintained together as a set in a common location, according to claim 1, additionally including a sensor to sense the passage of a magnet by the sensor and positioned with respect to the common location to sense the removal of a magnet from the common location or the addition of a magnet to the common location, and means for keeping track of the number of magnets removed and the number of magnets added to the common location.

3. A system for determining presence or absence of individual items making up a set of items normally maintained together as a set in a common location, according to claim 2, wherein the items are a set of golf clubs and the common location is a golf bag.

4. A system for determining presence or absence of individual items making up a set of items normally maintained together as a set in a common location, according to claim 3, wherein each golf club has a grip portion at one end thereof and the magnet secured to each respective item is secured in the grip portion of each respective golf club.

5. A system for determining presence or absence of individual items making up a set of items normally maintained together as a set in a common location, according to claim 4, additionally including an elongate body adapted to be positioned in the golf bag similarly to a golf club and mounting the magnetic field sensor at one end thereof to be positioned in the bottom of the golf bag when the elongate body is positioned in the golf bag and mounting the sensor along the elongate body toward the opposite end thereof to be positioned above the magnetic field sensor when the elongate body is positioned in the golf bag.

6. A system for determining presence or absence of individual items making up a set of items normally maintained together as a set in a common location, according to claim 5, wherein the means to compare the magnetic field sensed and to keep track of the number of magnets removed from the common area and number of magnets added to the common area is a programmed computer.

7. A system for determining presence or absence of individual items making up a set of items normally maintained together as a set in a common location, according to claim 6, wherein the computer is a microprocessor.

8. A system for determining presence or absence of individual items making up a set of items normally maintained together as a set in a common location, according to claim 6, additionally including a sensor to sense when the golf bag moves and upon movement of the golf bag, to cause an indication to be given if a golf club is missing from the bag.

9. A system for determining presence or absence of individual items making up a set of items normally maintained together as a set in a common location, according to claim 8, wherein the sensor to sense when the golf bag moves is a sensor selected from the gorup of sensors consisting of a motion sensor, a magnetic compass, or a vibration sensor.

10. A system for determining presence or absence of individual items making up a set of items normally maintained together as a set in a common location, according to claim 8, wherein the indication given is an audible indication.

11. A system for determining presence or absence of individual items making up a set of items normally maintained together as a set in a common location, comprising:
a set of items normally maintained together as a set in a common location;
a magnet secured to each respective item in the set of items, each magnet positioned with respect to the respective item to which it is secured so as to enter the common location when the item is added to the common location and to leave the common location when the item is removed from the common location;
a sensor to sense the passage of a magnet by the sensor and positioned with respect to the common location to sense the removal of a magnet from the common location or the addition of a magnet to the common location, and
means for keeping track of the number of magnets removed and the number of magnets added to the common location, the excess of the number of magnets removed from the common location over the number of magnets added to the common location indicating the number of items missing from the common location.

12. A system for determining presence or absence of individual items making up a set of items normally maintained together as a set in a common location, according to claim 11, wherein the items are a set of golf clubs and the common location is a golf bag.

13. A system for determining presence or absence of individual items making up a set of items normally maintained together as a set in a common location, according to claim 12, wherein each golf club has a grip portion at one end thereof and the magnet secured to each respective item is secured in the grip portion of each respective golf club.

14. A system for determining presence or absence of individual items making up a set of items normally maintained together as a set in a common location, according to claim 13, additionally including an elongate body adapted to be positioned in the golf bag similarly to a golf club and mounting the sensor in the elongate body to be positioned toward the top of the golf bag when the elongate body is positioned in the golf bag.

15. A system for determining presence or absence of individual items making up a set of items normally maintained together as a set in a common location, according to claim 14, wherein the means to keep track of the number of magnets removed from the common area and number of magnets added to the common area is a programmed computer.

16. A system for determining presence or absence of individual items making up a set of items normally maintained together as a set in a common location, according to claim 15, wherein the computer is a microprocessor.

17. A system for determining presence or absence of individual items making up a set of items normally maintained together as a set in a common location, according to claim 15, additionally including a sensor to sense when the golf bag moves and upon movement of the golf bag, to cause an indication to be given if a golf club is missing from the bag.

18. A system for determining presence or absence of individual items making up a set of items normally maintained together as a set in a common location, according to claim 17, wherein the sensor to sense when the golf bag moves is a sensor sselected from the group of sensors consisting of a motion sensor, a magnetic compass, or a vibration sensor.

19. A system for determining presence or absence of individual items making up a set of items normally maintained together as a set in a common location, according to claim 17, wherein the indication given is an audible indication.

20. A method of determining presence or absence of individual items making up a set of items normally maintained together as a set in a common location, comprising the steps of:
securing a magnet to each of the items of the set of items;
obtaining a measurement of total magnetic field when all items are present in the common location to obtain an expected total magnetic field when all items are present;
sensing the total magnetic field present in the common location at a particular time when it is desired to know if all items are present in the common location; and
comparing the sensed total magnetic field with the expected total magnetic field when all items are present to determine if all items are present at the particular time.

21. A method of determining presence or absence of individual items making up a set of items normally maintained together as a set in a common location, comprising the steps of:
securing a magnet to each of the items of the set of items;
assembling all items in the common location;
after assembling all items in the common location, sensing movement of magnets out of and into the common location; and
keeping track of all magnets removed from the common location and all magnets added to the common location thereby knowing whether an item is missing from the common location to determine if all items are present at a particular time in the common location.
